(19) United States
(12) Patent Application Publication
(10) Pub. No.: US 2009/0266773 A1
(43) Pub. Date: Oct. 29, 2009

(54) PORTABLE BIKE CARRIER

(76) Inventor: JEREMY JANECZKO, Topanga, CA (US)

Correspondence Address: Law Office of Michael N. Cohen, P.C., 9025 Wilshire Blvd., Suite 301, Beverly Hills, CA, 90211, US

(21) Appl. No.: 12/111,577

(22) Filed: Apr. 29, 2008

(51) Int. Cl. B62H 3/04

(52) U.S. Cl. 211/5

(57) ABSTRACT

A portable bike carrying device for transportation of bikes inside a vehicle is disclosed. The device includes a scalloped platform, a metal casted skewer mount containing a quick release bolt, nuts and washers and Velcro hook to insure grip to vehicle carpet. The bike carrier is equipped on the back of the vehicle by folding down the seat. The bike is mounted on the platform in an upright position and the front fork of the bicycle is attached to the skewer mount and tightened down for securing the bike during travel. The paddle design includes a handle for easily and quickly removing and storing the carrier. The platform may have various shapes and sizes such as paddle, disc or other shapes and is manufactured of wood and/or plastic.

### CROSS-REFERENCE TO RELATED APPLICATIONS

This application claims the benefit of U.S. Provisional Patent Application 60/797,305, filed on May 3, 2006.

### STATEMENT REGARDING FEDERALLY SPONSORED RESEARCH AND DEVELOPMENT

Not Applicable.

### FIELD OF THE INVENTION

This invention relates to bike carriers, and more particularly to a portable bike carrier for the transportation of bikes inside a vehicle.

### DISCUSSION OF RELATED ART

With the growing popularity of bicycling as a recreational activity, various systems are designed for mounting and carrying bicycles on automobiles. The bike racks currently available are generally not adaptable to all four wheeled vehicles and most of the bike carriers are cumbersome and can neither be stored nor carried easily by the biker and are difficult to install and may cause damage to the vehicles. Different design considerations are involved from bike carriers because of the substantially great weight and handling difficulty of motorcycles. Further, these systems are generally limited in their ability to accommodate different bicycle sizes, styles and designs.

Some devices carry bicycles on the top of the vehicle. In such case of roof rack style bike mounts, the bike on the top of the vehicle creates wind drag on the vehicle during transport. Moreover, it requires great effort to lift the bike up to the vehicle roof and take it down, which implies the risk of falling over. Carriers for enabling bikes to be carried at the front or rear end of the vehicles are also known in the prior art. The rear bumper mounted carrier has been popular because of its smaller size and low lift height. However, the rear bumper mounted carriers are difficult to attach to a vehicle, difficult to use and/or are structurally deficient. Moreover, the substitution, in most passenger vehicles, of soft energy absorbing bumpers for steel bumpers has almost entirely obsoleted the bumper mounted carrier. In such an arrangement, the bikes usually rub is against the vehicle, causing scuffing of the paint finish with possibly other damage as well.

Many bike carriers are rear mounted external mounts, which leaves the bikes exposed to collision; theft and the possibility of dropping off of the vehicle. The rear mounted carriers require the use of retaining ropes and straps for securing bicycles to the carriers. The use of the retaining ropes and straps has caused the reliability of the bicycle mountings to depend on some extent on the skill and care of the user. Various systems have been developed to secure and stabilize bicycles on vehicle mounted cross arms. It is important for a rack to permit the bike to be locked on to prevent unauthorized removal. In systems utilizing fork blocks, this is usually accomplished by providing a lock associated with the skewer to prevent the skewer from being opened. Existing lock designs are either unnecessarily complex or not sufficiently secure.

Therefore, there is a need for a device that is to be placed inside a vehicle to aid in the safe transportation of bicycles. There is also a need for a bike carrier containing a means to permit the bicycle to be mounted securely to the bike mount in the vehicle. Additionally, such carrier should easily and quickly be removed and stored and should save space and time. The present invention accomplishes these objectives.

### SUMMARY OF THE INVENTION

The present invention is a device that can be placed inside a vehicle to aid in the transportation of bicycles. The device includes a scalloped platform in a paddle design, skewer mount and a Velcro hook. The platform is used to laterally stabilize the bike mounted to the carrier, the skewer mount clamp the front fork of the bike down to the platform, and the Velcro hook insures grip to the vehicle carpet on the back of the folded down seat. The paddle platform includes a handle for easily removing the carrier. The skewer mount includes a quick release bolt that travels through the mount and secure the bike front to the mount and the mount is attached to the platform using bolts, washers and nuts.

The portable bike carrying device is placed flat on the carpeted seat back by folding down the seat of the vehicle. The bike is loaded into the vehicle and the front fork of the bike is mounted to the skewer mount on the platform, and the vehicle is positioned upright creating more room within the vehicle. After removing the bike from the vehicle, the carrier can easily and quickly be removed stored.

In one embodiment of the invention, the platform includes at least one of a paddle and disc design. The platform is essentially manufactured with wood or plastic for the body and the skewer mount is manufactured using a steel or aluminum cast.

Other features and advantages of the present invention will become apparent from the is following more detailed description, taken in conjunction with the accompanying drawings, which illustrate, by way of example, the principles of the invention.

### DESCRIPTION OF THE DRAWINGS

FIG. 1 is a perspective top view of the invention, illustrating a portable bike carrier for transporting bikes inside a vehicle.

FIG. 2 is a perspective bottom view of the invention, illustrating a Velcro hook to insure grip to the vehicle carpet.

FIG. 3 is a perspective side view of the invention, illustrating the paddle platform with a skewer mount, slopped edges, and hooks.

FIG. 4 is a close view of the invention, illustrating the skewer mount attached to the paddle platform.

FIG. 5 is a schematic top view of an alternate embodiment of the invention, illustrating a bike carrying mount.

FIG. 6 is a schematic side view of the alternate embodiment of the invention, illustrating the skewer mount attached to a taller and more three-dimensional center portion.

FIG. 7 is a perspective top view of another alternate embodiment of the invention, illustrating a portable bike carrier with a disc platform.

FIG. 8 is a perspective side view of another alternate embodiment of the invention, illustrating a disc platform with a skewer bolted on.

FIG. 9 is a perspective view of the preferred embodiment, illustrating a bike mounted on a bike carrier inside a vehicle.

### DETAILED DESCRIPTION OF THE PREFERRED EMBODIMENT

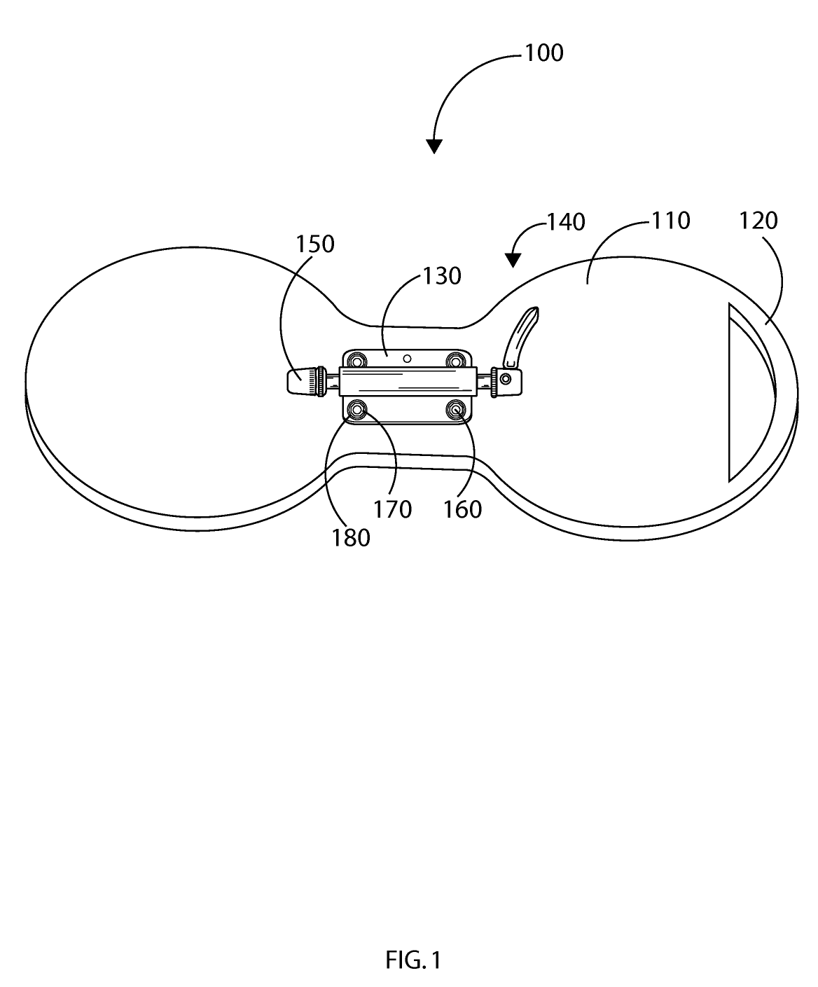

Referring to FIG. 1 is a perspective top view of a portable bike carrier 100 for the transportation of a bike inside a vehicle, which is equipped with folded down seats. The bike carrier 100 includes a scalloped platform 110 bearing a handle portion 120 and a skewer mount 130. The scalloped platform 110 is essentially in a paddle design 140 to laterally stabilize the bike mounted to the carrier 100. The skewer mount 130 is used to clamp the front fork of the bike down to the platform 110. The skewer mount 130 includes a quick release bolt 150 that travels through the mount 130 to secure the bike fork (not shown). The skewer mount 130 is placed on the platform 110 with the aid of bolts 160, and nuts 170 and lock washer 180.

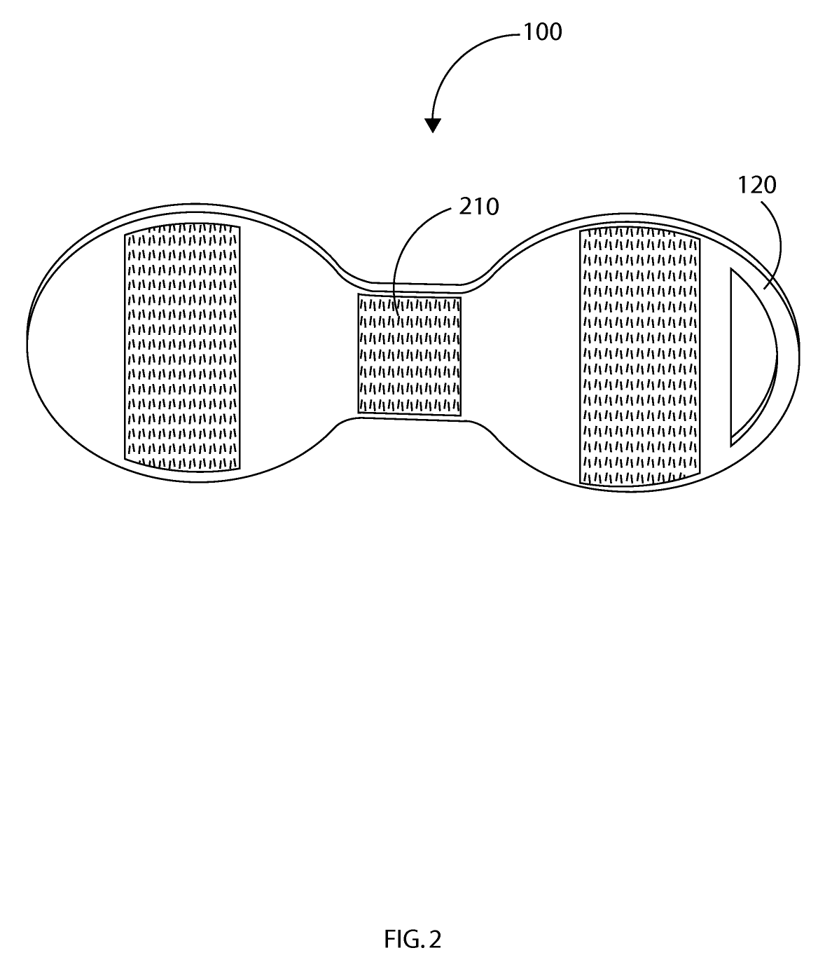

Referring to FIG. 2, a bottom view of a portable bike carrier 100 is illustrated. The illustration displays a hook Velcro 210, which is used to insure grip to the vehicle carpet on the back of the folded down seat (not shown).

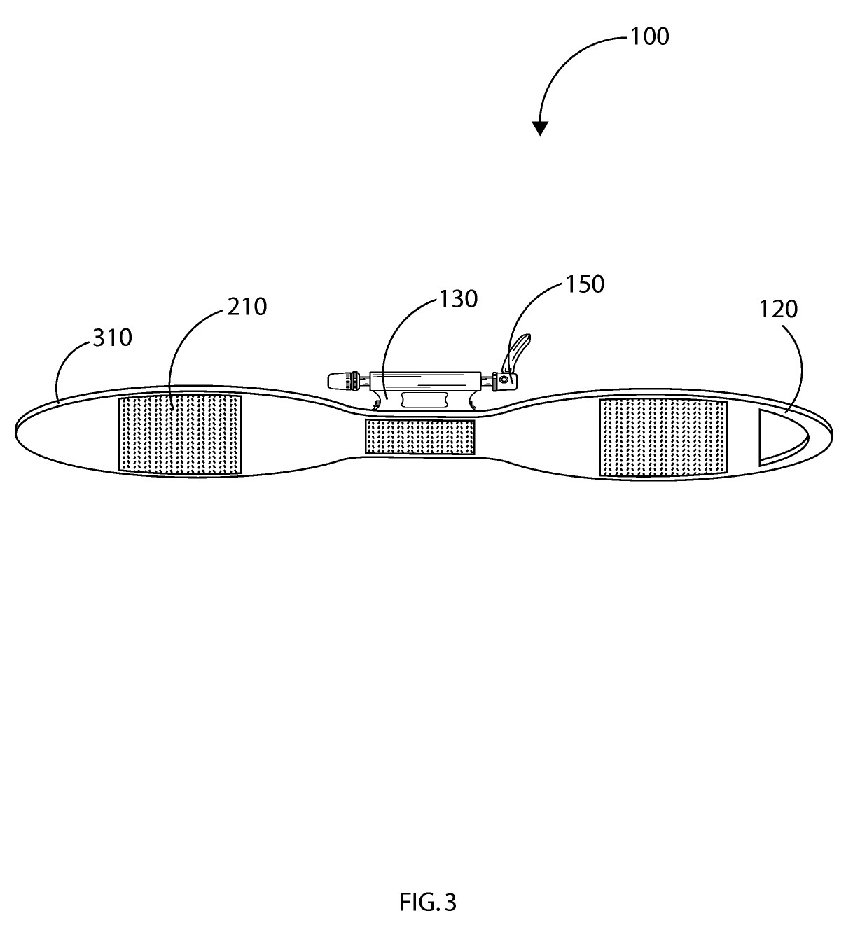

Referring to FIG. 3 is a side view of the portable bike carrier 100. The edges 310 are slopped and have a smooth and tapered look. The Velcro hook 210 attaches the carrier 100 to the vehicle carpet and the skewer mount 130 clamp the front fork of the bike onto the carrier 100. The bike carrier 100 is manufactured with a wood or plastic for the platform 110 and steel or aluminum cast for the skewer mount 130. The handle 120 enables easy removal of the carrier 100 from the vehicle after removing the bicycle.

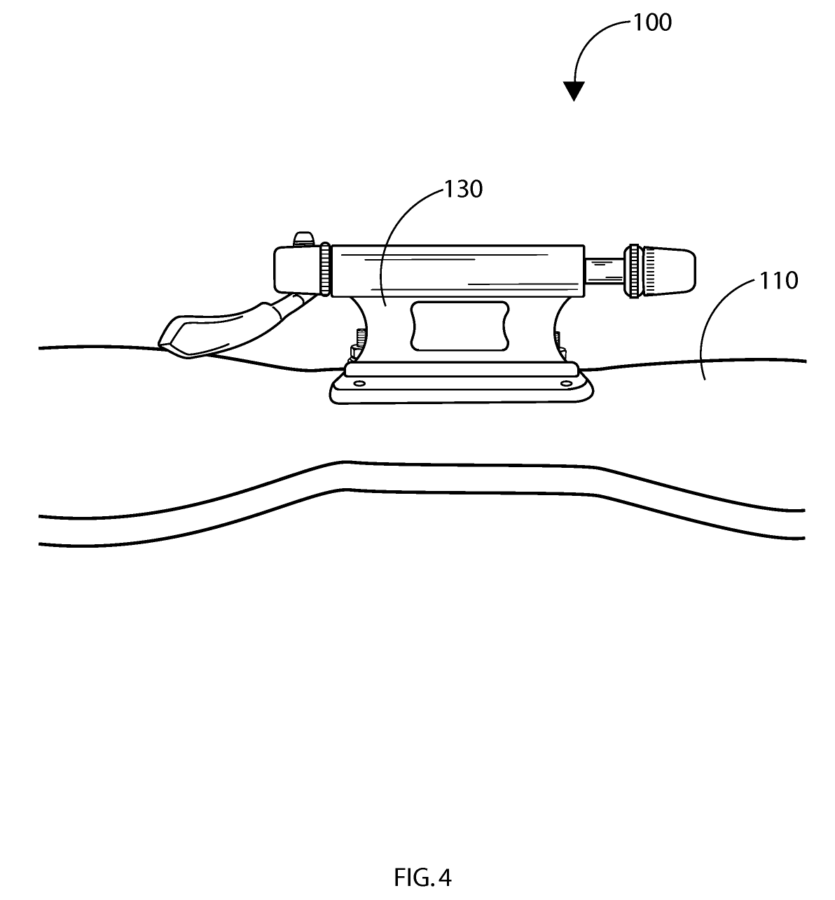

Referring to FIG. 4 is a close view of the bike carrier 100 illustrating a metal casted skewer mount 130 attached to the paddle platform 110. The front fork of bicycle is attached to the skewer mount 130 and tightened down for travel.

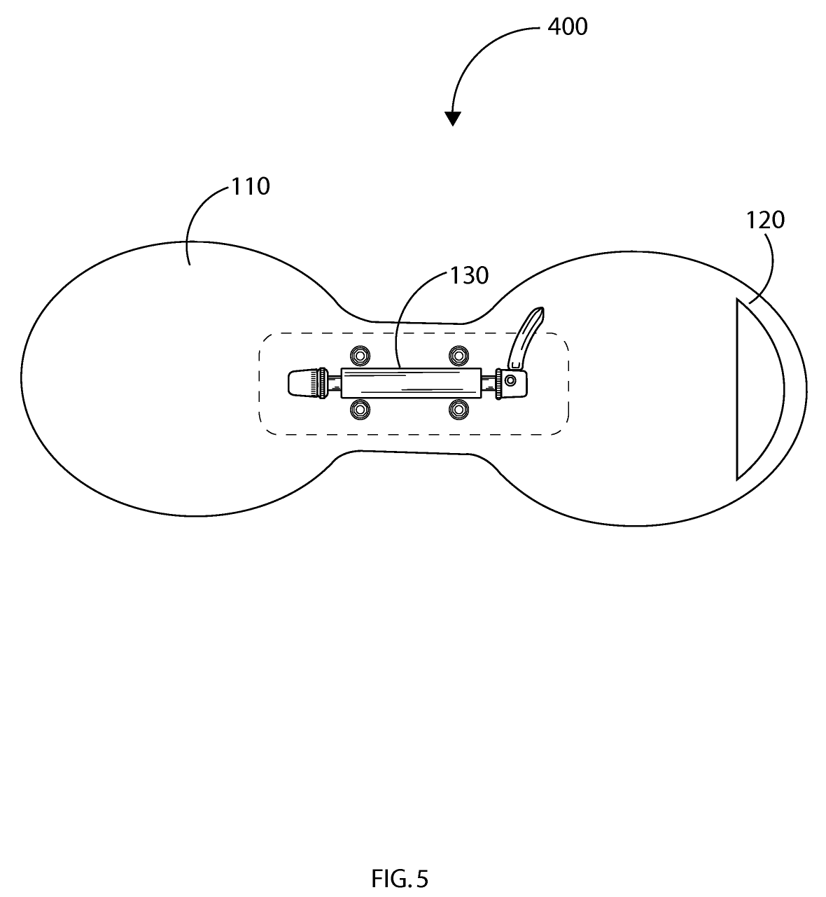

Referring to FIG. 5 is a schematic top view of an alternate embodiment of the bike carrier 400 for transporting bikes inside a vehicle. The carrier 400 includes a platform 110 in a paddle design 140 with a handle 120 and a skewer mount 130. The bike carrier 400 appears to be sleeker, smoother and lighter.

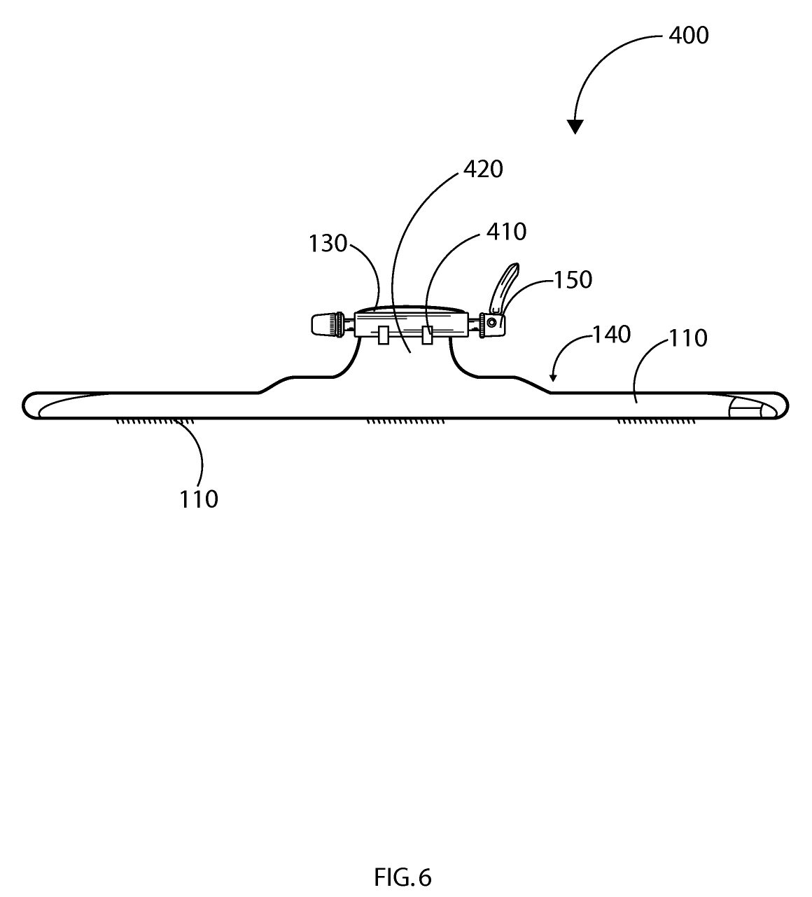

Referring to FIG. 6 is a schematic side view of the embodiment of FIG. 5. The carrier 400 includes a platform 110 in a paddle design 140 which is manufactured of plastic. The skewer mount 130 includes a quick release bolt 150 and locking engagements 410 such as bolts, nuts and lock washer. The center part 420 where the mount 130 attaches to the platform 110 is taller and more three-dimensional. The platform 110 is essentially black or multi-colored. The bike carrier 400 is equipped to the vehicle carpet using Velcro hook 210.

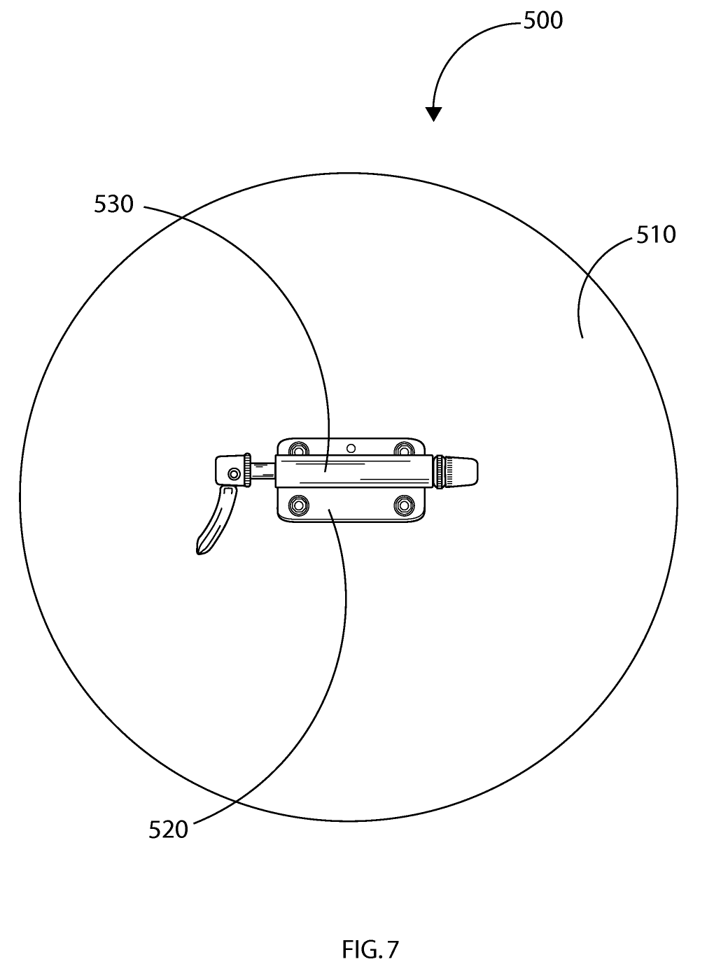

Referring to FIG. 7 is a top view of another alternate embodiment of the invention, in which a bike carrier 500 with a disc platform 510 is shown. The illustration displays a disc platform 510 and a skewer mount 520 used to clamp the front fork of the bike. The skewer mount 520 includes a quick release bolt 530 that travels through the mount 520 to secure the bike fork.

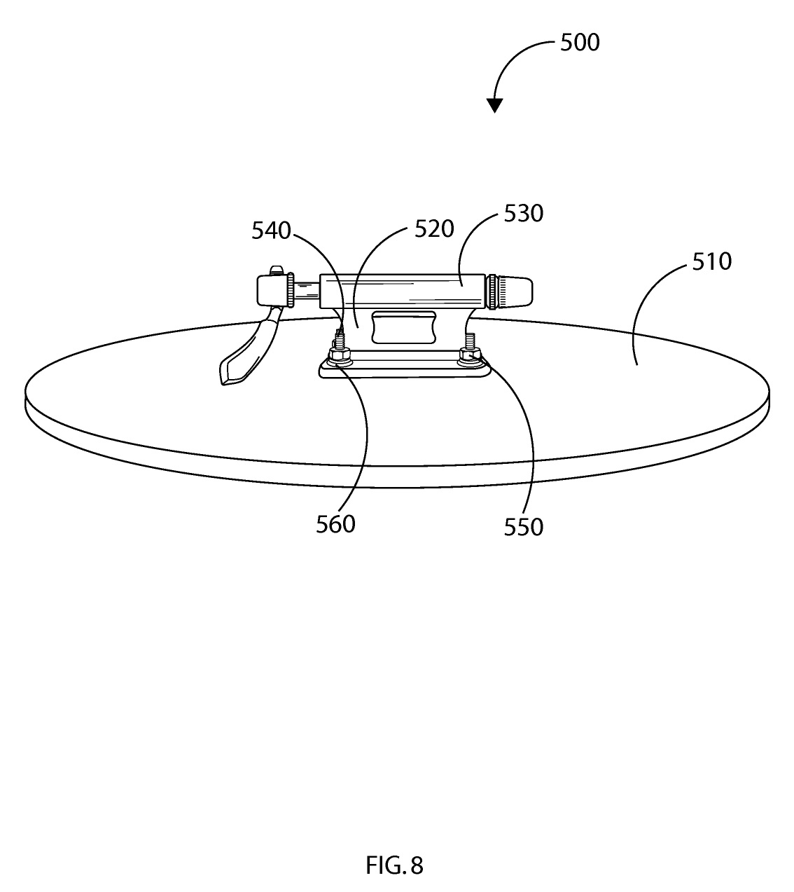

Referring to FIG. 8 is a side view of the embodiment of FIG. 7. A skewer mount 520 comprising a quick release bolt 530 is mounted on the platform 510. The skewer mount 520 is incorporated to the platform 510 employing bolt 540, nut 550 and washer 560.

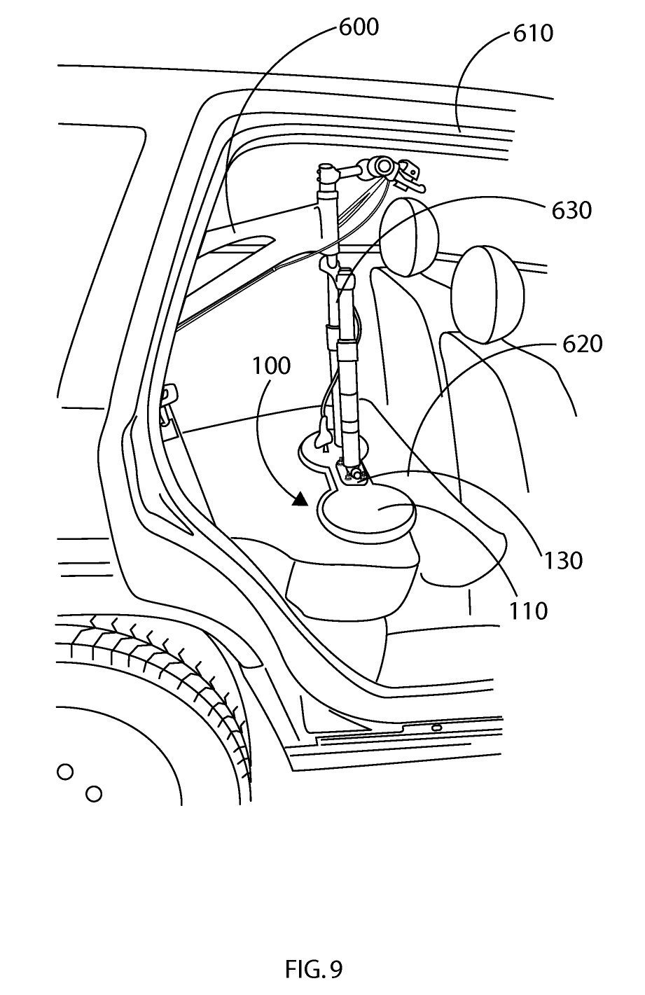

Referring to FIG. 9 is a perspective view of a bike 600 mounted on the bike carrier 100 placed inside the vehicle 610. The bike carrier 100 can be mounted to the vehicle 610 by folding down the rear vehicle seat 620 in any vehicle large enough to contain a bike 600 and the carrier 100 can be placed on the back of the carpeted seat back. The bike 600 is loaded into the vehicle 610 and the front fork 630 of the bike 600 is secured to the skewer mount 130 attached to the platform 110. The bike 600 is kept upright, creating more room within the vehicle 610 and securing the bike 600 during travel. After removing the bike 600 from the vehicle 610 the carrier 100 can easily and quickly be removed and stored.

Typical applications of the present invention contemplate but are not limited to product manufacturing, installation, and maintenance. The foregoing enumeration of embodiments has been for illustrative purposes only. Other embodiments, combinations of embodiments and combinations of features are also within the scope and spirit of the teachings described herein, as will be apparent to persons skilled in the art of these teachings.

While a particular form of the invention has been illustrated and described, it will be apparent that various modifications can be made without departing from the spirit and scope of the invention. For example, structure, materials, procedure and the like that will fall within the scope of the invention. In any event, it is understood that other platform designs are also possible. Accordingly, it is not intended that the invention be limited, except as by the appended claims.

What is claimed is:

1. A portable bike carrying device for transporting bikes inside a vehicle, the carrier comprising:
a scalloped platform to laterally stabilize the bike mounted to the carrier,
a skewer mount to clamp the front fork of the bike down the platform, and
a Velcro hook to insure grip to vehicle carpet on the back of the folded down seat.

2. The portable bike carrier of claim 1, wherein said platform is at least one of paddle or disc in design.

3. The portable bike carrier of claim 1, wherein the scalloped paddle platform includes at least a handle for easy removal of the carrier.

4. The portable bike carrier of claim 1, wherein the skewer mount includes a quick release bolt that travels through the mount to secure the bike fork.

5. The portable bike carrier of claim 1, wherein the skewer mount includes at least one bolt, nut and washer to attach the mount on the platform.

6. The portable bike carrier of claim 1, wherein the carrier is placed on the back of the carpeted seat back by folding down the seat.

7. The portable bike carrier of claim 1, wherein the carrier is placed flat on the vehicle carpet with Velcro hook and the bike is loaded into the vehicle, thereby securing the front fork of the bike to the skewer mount on the platform.

8. The portable bike carrier of claim 1, wherein the bike is placed upright on the platform thereby creating more space within the vehicle.

9. The portable bike carrier of claim 1, wherein the platform is made from materials that are at least one of plastic and wood.

10. The portable bike carrier of claim 1, wherein the skewer mount is manufactured from at least one of steel cast and aluminum cast.

11. The portable bike carrier of claim 1, wherein the invention is equipped within in a vehicle having folding down seats.
